(19) United States
(12) Patent Application Publication
(10) Pub. No.: US 2025/0299071 A1
(43) Pub. Date: Sep. 25, 2025

(54) A method of mine disaster tracing based on knowledge graph

(71) Applicant: CCTEG CHONGQING RESEARCH INSTITUTE, Chongqing (CN)

(72) Inventors: Zhigang Zhang, Chongqing (CN); Haitao Sun, Chongqing (CN); Yabo He, Chongqing (CN); Wenji Han, Chongqing (CN); Yanbao Liu, Chongqing (CN); Gangli Yao, Chongqing (CN); Shan Si, Chongqing (CN); Yun Sun, Chongqing (CN); Lang Li, Chongqing (CN); Na Yang, Chongqing (CN); Hanying Tang, Chongqing (CN)

(21) Appl. No.: 18/862,170

(22) PCT Filed: Oct. 26, 2023
(86) PCT No.: PCT/CN2023/126635

§ 371 Date: Nov. 1, 2024

(30) Foreign Application Priority Data
Apr. 24, 2023 (CN) 2023104507936

(51) Int. Cl. G06N 5/025; G06N 5/045

(52) U.S. Cl. CPC G06N 5/025; G06N 5/045

(57) ABSTRACT

The present invention discloses a mine disaster tracing method based on a knowledge graph, applied in coal mine safety. First, a mine disaster-related knowledge graph is built, involving three main steps: constructing a conceptual model, extracting entities from relational databases and geological maps, and establishing entity relationships based on location and process logic. Next, characteristic indexes and transmission rules for entity objects are set, categorizing entities into four types: discrete reporting, continuous monitoring, geological structure, and geological continuity. When an early warning occurs, disaster tracing is performed using the entity transmission rules and a graph traversal algorithm, identifying direct and root causes. This invention offers systematic and timely disaster tracing by utilizing a specialized knowledge graph and graph algorithms.

### FIELD OF INVENTION

The present invention belongs to the field of coal mine safety and relates to a mine disaster tracing method based on a knowledge graph.

### BACKGROUND ART OF THE INVENTION

Mine disasters are mainly caused by four major factors: coal seam geology, ventilation environment, facility and equipment, and personnel construction. Personnel construction breaks the existing balance of a mine system, which is often a direct cause of accidents. However, anomalies of coal seam geology, change of ventilation environment and aging of facility and equipment are root causes of accidents.

With long-term effort of experts and scholars in China, China has formed a technical system of disaster monitoring and disaster control for various disasters and proposed a large number of prediction and early warning methods for a single disaster, providing effective technical means for pre-disaster early warning, escape from disasters and post-disaster analysis. However, various prediction methods can only find a single cause of disaster, but cannot find all possible direct causes and root causes effectively and completely.

Mine disaster tracing is to trace the source of a disaster that has happened or is happening and find direct causes and root causes of the disaster, so as to achieve the rapid and effective removal of the disaster and minimize the loss caused by the disaster. In the latency period of the disaster, it is an urgent problem to carry out disaster tracing by effective means and eliminate or weaken the influence of factors that may cause the disaster, so as to effectively prevent the further breeding of the disaster and eventually the occurrence of catastrophe.

### DISCLOSURE OF THE INVENTION

In view of this, the purpose of the present invention is to provide a mine disaster tracing method based on a knowledge graph, which can find direct causes and root causes of potential disasters in a timely and complete manner when a mine disaster early warning occurs, so as to eliminate or weaken the influence thereof and effectively prevent the further breeding of the disaster and eventually the occurrence of catastrophe.

To achieve the above purpose, the present invention provides the following technical solution:

A mine disaster tracing method based on a knowledge graph, comprising the following steps:
S1: establishing a mine disaster-related knowledge graph;
S2: constructing characteristic indexes of entity objects, and determining transmission rules of the entity objects;
S3: after a disaster early warning occurs in a certain place of a mine, carrying out mine disaster tracing based on the transmission rules of the entity objects and a graph traversal algorithm, and presenting direct causes and root causes of a disaster.

Optionally, the S1 comprises the following steps:
S11: establishing a conceptual model for mine disaster tracing of dust, gas, fire, mine pressure and water disaster by summarizing expert experience;
S12: collecting entity objects of a mine from a relational database of a data center, and using a storage primary key as unique identification of the entity objects, wherein attribute information contains object names, object types, object storage table names, object monitoring status field names and object monitoring value field names, and binding spatial information combined with a geological map;
S13: establishing a relationship between entities based on a position relationship and process logic in the conceptual model, thus establishing the mine disaster-related knowledge graph, wherein the position relationship specifically adopts an inclusion relationship, an intersection relationship and an adjacency relationship.

Optionally, in the S13, the position relationship between entity objects is calculated from spatial information topology, spatial information of the entity objects are divided into three types: point, line and surface, and the model specifically adopts three position relationships of inclusion, intersection and adjacency; and for the adjacency relationship, a spatial distance Δd of two entity objects is less than a certain value D, and the value of D is determined according to drawing accuracy and calculation accuracy.

Optionally, for four types of indexes contained in the S2, indexes M and Sₜ involving continuous monitoring data are based on continuous monitoring data for last 5 minutes, and indexes Q and G involving geological continuity data are based on geographic data cloud maps;

In a calculation method for the maximum value index M of a monitoring value, direct sequencing and direct valuing are adopted; and a specific calculation formula is as follows:

$$M = {max}_{{t}_{1} < t < {t}_{0}} {x}_{t} \qquad ( 1 )$$

wherein xₜ is a monitoring value at time t, t₀ is current time, and t₁ is time before 5 minutes;
A calculation method for the variation trend index Sₜ of the monitoring value is as follows: a principle of first order linear fitting with a least square method is adopted; and a specific calculation formula is as follows:

$${S}_{t} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 2 )$$

wherein xᵢ is a difference between i^{th} data time and the current time in the last 5 minutes, yᵢ is a monitoring value at the i^{th} data time, x̅ is an average value of xᵢ in the last 5 minutes, y̅ is an average value of yᵢ in the last 5 minutes, and n is the total amount of monitoring data in the last 5 minutes;
A calculation method for the geographic interpolation index Q is as follows: the interpolation index Q at position 0 is directly valued based on the geographic data cloud maps; and a specific calculation formula is as follows:

$$Q = {f}_{0} \qquad ( 3 )$$

wherein f₀ is a value at a corresponding grid point, and h is spacing of grid points;
A calculation method for the geographic gradient index G is as follows: the gradient index G at position 0 is 2-norm of the gradient here, and gradient calculation is based on a finite difference method; and a specific calculation formula is as follows:

$$G = {‖ \frac{{f}_{1} - {f}_{3}}{2 h} \vec{i} + \frac{{f}_{4} - {f}_{2}}{2 h} \vec{j} ‖}_{2} \qquad ( 4 )$$

wherein f₁, f₂, f₃ and f₄ are values at four grid points, and h is spacing of grid points;
Optionally, in the S2, characteristic indexes of entity objects are constructed, transmission rules of the entity objects are determined, and the entity objects are divided into four types according to the needs of data types: a discrete reporting type, a continuous monitoring type, a geological structure type and a geological continuity type.

Optionally, the characteristic indexes and transmission rules of the entity objects of the discrete reporting type are compared with a normal threshold interval of the entity objects based on latest reported data; if beyond the normal threshold interval, the transmission rules are satisfied; otherwise, the transmission rules are not satisfied.

Optionally, the characteristic indexes and transmission rules of the entity objects of the continuous monitoring type comprise judgment of a sensor monitoring status and a sensor monitoring value; firstly, the sensor monitoring status is judged; if the monitoring status is “faulty” or “off-line”, it is directly determined that the transmission rules are satisfied; otherwise, next judgment is made; and then, the maximum value index M and the variation trend index Sₜ of the monitoring value of the sensor in the last 5 minutes are calculated, and the rule is that if one of the two indexes exceeds the critical value, the transmission rules are satisfied; otherwise, the transmission rules are not satisfied.

Optionally, the characteristic indexes and transmission rules of the entity objects of the geological structure type are determined by intersection of a structure buffer area, and the rule is that if an early warning area intersects with a 20 m buffer area of the geological structure, the transmission rules are satisfied; otherwise, the transmission rules are not satisfied.

Optionally, the characteristic indexes and transmission rules of the entity objects of the geological continuity type are determined by thresholds of geographic cloud maps, the indexes are a geographic interpolation index Q and a geographic gradient index G, and the rule is that if one of the two indexes exceeds the critical value, an anomaly exists; otherwise, no anomaly exists.

Optionally, in the S1, on the constructed mine disaster-related knowledge graph, based on the established transmission rules of entity objects and combined with a depth-first algorithm, a breadth-first algorithm or an A* algorithm graph traversal algorithm, mine disaster tracing is carried out to generate a disaster cause tree, and direct causes and root causes of a disaster are finally found.

The present invention has the beneficial effects that: a comprehensive conceptual model for disaster-related transmission can be constructed by making full use of expert knowledge, whether related factors are transmitted can be effectively judged by indexes and rules, direct causes and root causes of a disaster can be found quickly, accurately and comprehensively after a disaster early warning, and further breeding of the disaster and even occurrence of catastrophe can be effectively prevented by taking targeted control measures.

Other advantages, objectives and features of the present invention will be illustrated in the following description to some extent, and will be apparent to those skilled in the art based on the following investigation and research to some extent, or can be taught from the practice of the present invention. The objectives and other advantages of the present invention can be realized and obtained through the following description.

### DESCRIPTION OF DRAWINGS

To enable the purpose, the technical solution and the advantages of the present invention to be more clear, the present invention will be preferably described in detail below in combination with the drawings, wherein:

FIG. 1 is a flow chart of a mine disaster tracing method based on a knowledge graph;

FIG. 2 shows a conceptual model of a dust disaster early warning knowledge graph;

FIG. 3 shows a conceptual model of a gas disaster early warning knowledge graph;

FIG. 4 shows a conceptual model of a fire disaster early warning knowledge graph;

FIG. 5 shows a conceptual model of a mine pressure disaster early warning knowledge graph;

FIG. 6 shows a conceptual model of a water disaster early warning knowledge graph;

FIG. 7 is a schematic diagram of calculation points of values and gradients based on geographic data cloud maps;

FIG. 8 is a schematic diagram of spatial inclusion, intersection and adjacency position relationships;

FIG. 9 is a flow chart of specific determination of mine disaster tracing based on a depth-first graph algorithm.

### DETAILED DESCRIPTION OF THE INVENTION

Embodiments of the present invention are described below through specific embodiments. Those skilled in the art can understand other advantages and effects of the present invention easily through the disclosure of the description. The present invention can also be implemented or applied through additional different specific embodiments. All details in the description can be modified or changed based on different perspectives and applications without departing from the spirit of the present invention. It should be noted that the figures provided in the following embodiments only exemplarily explain the basic conception of the present invention, and if there is no conflict, the following embodiments and the features in the embodiments can be mutually combined.

Wherein the drawings are only used for exemplary description, are only schematic diagrams rather than physical diagrams, and shall not be understood as a limitation to the present invention. In order to better illustrate the embodiments of the present invention, some components in the drawings may be omitted, scaled up or scaled down, and do not reflect actual product sizes. It should be understandable for those skilled in the art that some well-known structures and description thereof in the drawings may be omitted.

Same or similar reference numerals in the drawings of the embodiments of the present invention refer to same or similar components. It should be understood in the description of the present invention that terms such as “upper”, “lower”, “left”, “right”, “front” and “back” indicate direction or position relationships shown based on the drawings, and are only intended to facilitate the description of the present invention and the simplification of the description rather than to indicate or imply that the indicated device or element must have a specific direction or constructed and operated in a specific direction, and therefore, the terms describing position relationships in the drawings are only used for exemplary description and shall not be understood as a limitation to the present invention; for those ordinary skilled in the art, the meanings of the above terms may be understood according to specific conditions.

### Embodiment 1

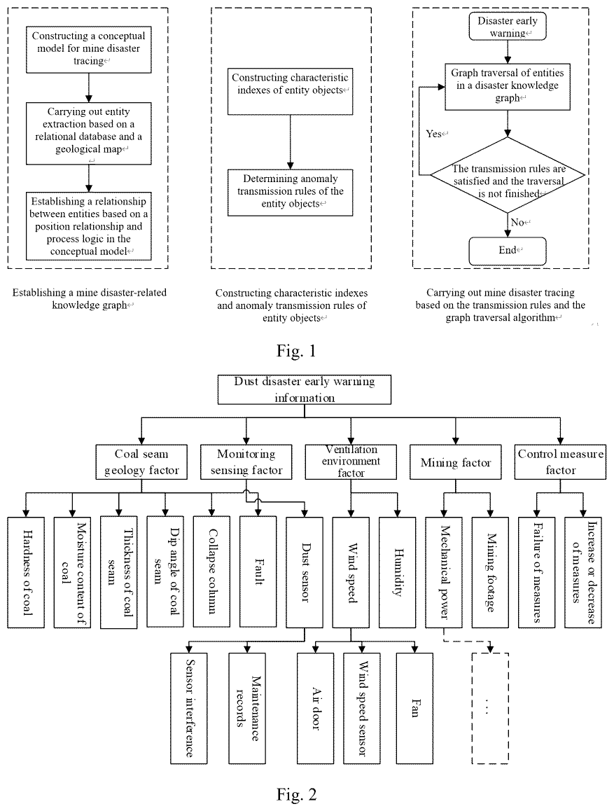

As shown in FIG. 1, the present invention provides a mine disaster tracing method based on a knowledge graph, comprising the following steps:
S1: establishing a mine disaster-related knowledge graph;
S2: constructing characteristic indexes of entity objects, and determining transmission rules of the entity objects;
S3: after a disaster early warning occurs in a certain place of a mine, carrying out mine disaster tracing based on the transmission rules of the entity objects and a graph traversal algorithm, and presenting direct causes and root causes of a disaster.

Step S1 mainly comprises the following three steps:
S11: establishing a conceptual model for mine disaster tracing of dust, gas, fire, mine pressure and water disaster by summarizing expert experience;
S12: collecting entity objects of a mine from a relational database of a data center, and using a storage primary key as unique identification of the entity objects, wherein attribute information contains object names, object types, object storage table names, object monitoring status field names and object monitoring value field names, and binding spatial information combined with a geological map;
S13: establishing a relationship between entities based on a position relationship and process logic in the conceptual model, thus establishing the mine disaster-related knowledge graph, wherein the position relationship specifically adopts an inclusion relationship, an intersection relationship and an adjacency relationship.

In step S2, characteristic indexes of entity objects are constructed, transmission rules of the entity objects are determined, and the entity objects are divided into four types according to the needs of data types: a discrete reporting type, a continuous monitoring type, a geological structure type and a geological continuity type.

The characteristic indexes and transmission rules of the entity objects of the discrete reporting type are compared with a normal threshold interval of the entity objects based on latest reported data; if beyond the normal threshold interval, the transmission rules are satisfied; otherwise, the transmission rules are not satisfied.

The characteristic indexes and transmission rules of the entity objects of the continuous monitoring type comprise judgment of a sensor monitoring status and a sensor monitoring value; firstly, the sensor monitoring status is judged; if the monitoring status is “faulty” or “off-line”, it is directly determined that the transmission rules are satisfied; otherwise, next judgment is made; and then, the maximum value index M and the variation trend index Sₜ of the monitoring value of the sensor in the last 5 minutes are calculated, and the rule is that if one of the index M and the index Sₜ exceeds the critical value, the transmission rules are satisfied; otherwise, the transmission rules are not satisfied.

The characteristic indexes and transmission rules of the entity objects of the geological structure type are determined by intersection of a structure buffer area, and the rule is that if an early warning area intersects with a 20 m buffer area of the geological structure, the transmission rules are satisfied; otherwise, the transmission rules are not satisfied.

The characteristic indexes and transmission rules of the entity objects of the geological continuity type are determined by thresholds of geographic cloud maps, the indexes are a geographic interpolation index Q and a geographic gradient index G, and the rule is that if one of the two indexes exceeds the critical value, an anomaly exists; otherwise, no anomaly exists.

On the mine disaster-related knowledge graph constructed in step S1, based on the transmission rules established in step S2 and combined with a depth-first algorithm, a breadth-first algorithm or an A* algorithm graph traversal algorithm, mine disaster tracing is carried out to generate a disaster cause tree, and direct causes and root causes of a disaster are finally found.

### Embodiment 2

Important steps, models, indexes, rules and algorithms in the present invention are respectively described in detail below:

The conceptual model for disaster tracing described in step S11 is constructed by expert experience. Conceptual relationship models of early warning information of dust, gas, fire, mine pressure and water disaster as well as a coal seam geology factor, a monitoring sensing factor, a ventilation environment factor, a mining factor and a control measure factor can be constructed respectively by expert experience.

For dust disaster early warning, a specific conceptual relationship model as shown in FIG. 2 can be constructed.

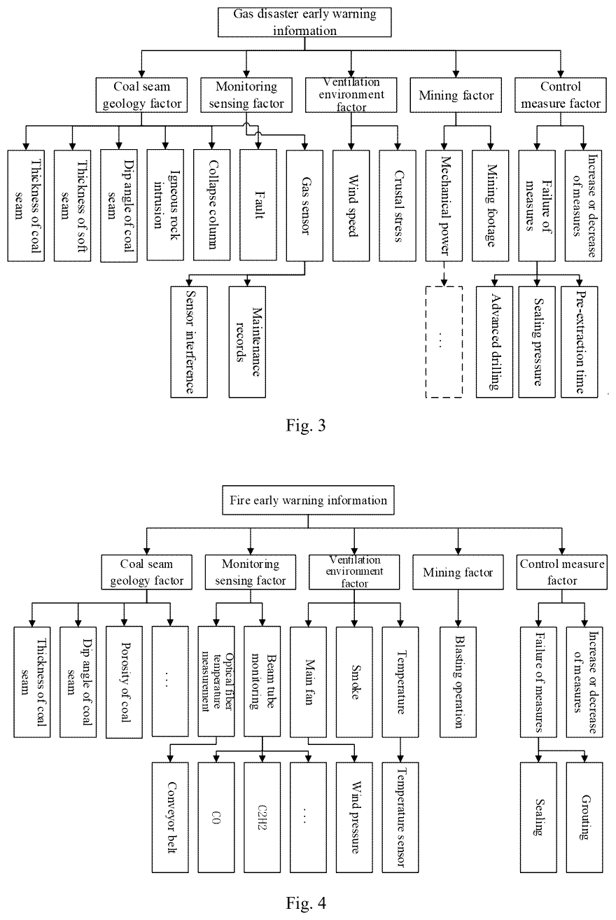

For gas disaster early warning, a specific conceptual relationship model as shown in FIG. 3 can be constructed.

For fire disaster early warning, a specific conceptual relationship model as shown in FIG. 4 can be constructed.

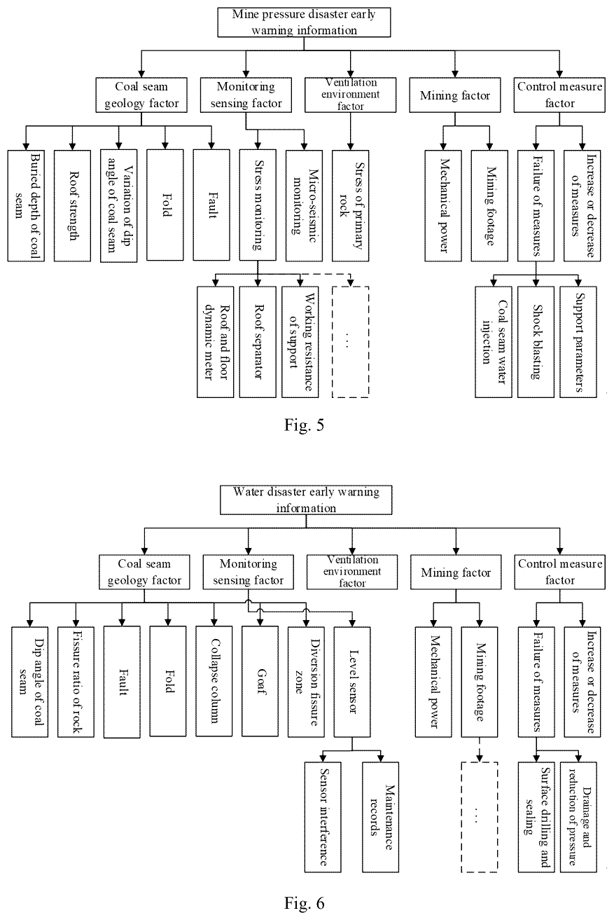

For mine pressure disaster early warning, a specific conceptual relationship model as shown in FIG. 5 can be constructed.

For water disaster early warning, a specific conceptual relationship model as shown in FIG. 6 can be constructed.

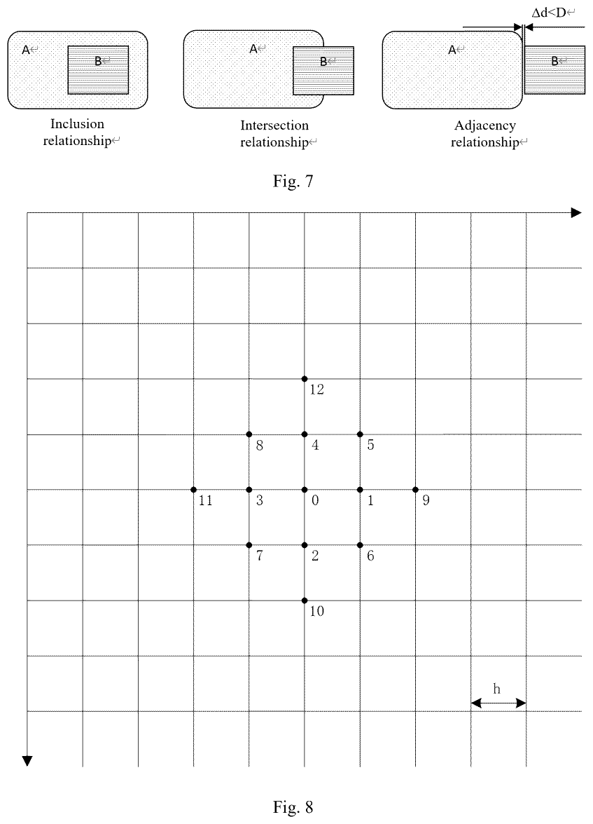

The position relationship between two entity objects mentioned in step S13 is calculated from spatial information topology, spatial information of the entity objects can be divided into three types: point, line and surface, and the model specifically adopts three position relationships of inclusion, intersection and adjacency, as shown in FIG. 7. For the adjacency relationship, a spatial distance Δd of two entity objects is generally less than a certain value D, and the value of D is determined according to drawing accuracy and calculation accuracy.

For four types of indexes contained in step S2, indexes M and Sₜ involving continuous monitoring data are based on continuous monitoring data for last 5 minutes, and indexes Q and G involving geological continuity data are based on geographic data cloud maps.

In a calculation method for the maximum value index M of a monitoring value, direct sequencing and direct valuing are adopted. A specific calculation formula is as follows:

$$M = {max}_{{t}_{1} < t < {t}_{0}} {x}_{t} \qquad ( 1 )$$

wherein xₜ is a monitoring value at time t, t₀ is current time, and t₁ is time before 5 minutes.

In a calculation method for the variation trend index Sₜ of the monitoring value, a principle of first order linear fitting with a least square method is adopted. A specific calculation formula is as follows:

$${S}_{t} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 2 )$$

wherein xᵢ is a difference between i^{th} data time and the current time in the last 5 minutes, yᵢ is a monitoring value at the i^{th} data time, x̅ is an average value of xᵢ in the last 5 minutes, y̅ is an average value of yᵢ in the last 5 minutes, and n is the total amount of monitoring data in the last 5 minutes.

In a calculation method for the geographic interpolation index Q, as shown in FIG. 8, the interpolation index Q at position 0 is directly valued based on the geographic data cloud maps. A specific calculation formula is as follows:

$$Q = {f}_{0} \qquad ( 3 )$$

wherein f₀ is a value at a corresponding grid point, and h is spacing of grid points.

In a calculation method for the geographic gradient index G, as shown in FIG. 8, the gradient index G at position 0 is 2-norm of the gradient here, and gradient calculation is based on a finite difference method. A specific calculation formula is as follows:

$$G = {‖ \frac{{f}_{1} - {f}_{3}}{2 h} \vec{i} + \frac{{f}_{4} - {f}_{2}}{2 h} \vec{j} ‖}_{2} \qquad ( 4 )$$

wherein f₁, f₂, f₃ and f₄ are values at four grid points, and h is spacing of grid points.

The transmission rules of the entity objects referred to in step S2 are summarized by four categories as shown in Table 1 below.

TABLE 1
Summary of Indexes and Transmission Rules of Entity Objects

| Entity | | Index | Index | Comprehensive |
|---|---|---|---|---|
| Object | Index | Value | Determination | Assessment |
| Type | Name | Type | Mode | Rule |
| Discrete | Latest reported | Numerical | Interval | Satisfying index |
| reporting | data | value | determination | determination |
| type | | | | |
| Continuous | Monitoring | Enumerated | Faulty and off- | Satisfying any |
| monitoring | status | value | line | index |
| type | Maximum | Numerical | Interval | determination |
| | value index M | value | determination | |
| | Variation trend | Numerical | Interval | |
| | index Sₜ | value | determination | |
| Geological | 20 m buffer | Geometric | Topological | Satisfying index |
| structure type | area | surface | intersection | determination |
| Geological | Geographic | Numerical | Interval | Satisfying any |
| continuity | interpolation | value | determination | index |
| type | index Q | | | determination |
| | Geographic | Numerical | Interval | |
| | gradient index | value | determination | |
| | G | | | |

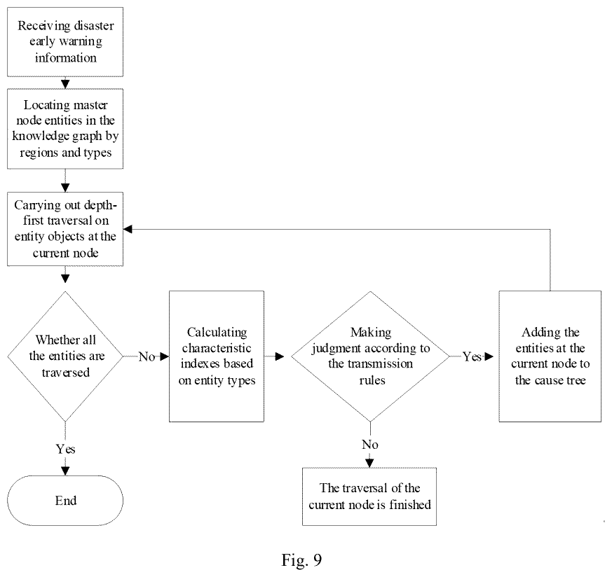

Specific execution steps based on the depth-first graph traversal algorithm in step S3 are shown in FIG. 9. When the system receives certain disaster early warning information, master node entity objects of early warning are located on the mine disaster-related knowledge graph constructed in step S1 according to the position of early warning and the type of the disaster. Depth-first traversal is started on entity objects from the current node. For each specific entity object traversed, the corresponding characteristic index is calculated according to the entity object type, and the specific calculation method is shown in formulas (1), (2), (3) and (4). On the basis of the characteristic index, whether the current entity node has an anomaly is judged according to the transmission rules: if no anomaly exists, the entity node is not added to the cause tree, the branch traversal of the node is finished, and the remaining child entity nodes of the parent entity node of the current node are traversed until the end; if an anomaly exists, all child entity nodes of the current node are further traversed until all the entity nodes with an anomaly are traversed.

Finally, it should be noted that the above embodiments are only used for describing, rather than limiting the technical solution of the present invention. Although the present invention is described in detail with reference to the preferred embodiments, those ordinary skilled in the art shall understand that the technical solution of the present invention can be amended or equivalently replaced without departing from the purpose and the scope of the technical solution. The amendment or equivalent replacement shall be covered within the scope of the claims of the present invention.

1. A mine disaster tracing method based on a knowledge graph, characterized in that: the method comprises the following steps:
S1: establishing a mine disaster-related knowledge graph;
S2: constructing characteristic indexes of entity objects, and determining transmission rules of the entity objects;
S3: after a disaster early warning occurs in a certain place of a mine, carrying out mine disaster tracing based on the transmission rules of the entity objects and a graph traversal algorithm, and presenting direct causes and root causes of a disaster.

2. The mine disaster tracing method based on a knowledge graph as claimed in claim 1, characterized in that: the S1 comprises the following steps:
S11: establishing a conceptual model for mine disaster tracing of dust, gas, fire, mine pressure and water disaster by summarizing expert experience;
S12: collecting entity objects of a mine from a relational database of a data center, and using a storage primary key as unique identification of the entity objects, wherein attribute information contains object names, object types, object storage table names, object monitoring status field names and object monitoring value field names, and binding spatial information combined with a geological map;
S13: establishing a relationship between entities based on a position relationship and process logic in the conceptual model, thus establishing the mine disaster-related knowledge graph, wherein the position relationship specifically adopts an inclusion relationship, an intersection relationship and an adjacency relationship.

3. The mine disaster tracing method based on a knowledge graph as claimed in claim 2, characterized in that: in the S13, the position relationship between entity objects is calculated from spatial information topology, spatial information of the entity objects are divided into three types: point, line and surface, and the model specifically adopts three position relationships of inclusion, intersection and adjacency; and for the adjacency relationship, a spatial distance Δd of two entity objects is less than a certain value D, and the value of D is determined according to drawing accuracy and calculation accuracy.

4. The mine disaster tracing method based on a knowledge graph as claimed in claim 1, characterized in that: for four types of indexes contained in the S2, indexes M and Sₜ involving continuous monitoring data are based on continuous monitoring data for last 5 minutes, and indexes Q and G involving geological continuity data are based on geographic data cloud maps;
in a calculation method for the maximum value index M of a monitoring value, direct sequencing and direct valuing are adopted; and a specific calculation formula is as follows:
$$M = {max}_{{t}_{1} < t < {t}_{0}} {x}_{t} \qquad ( 1 )$$
wherein xₜ is a monitoring value at time t, t₀ is current time, and t₁ is time before 5 minutes;
a calculation method for the variation trend index Sₜ of the monitoring value is as follows: a principle of first order linear fitting with a least square method is adopted;
and a specific calculation formula is as follows:
$${S}_{t} = \frac{{\sum }_{i = 1}^{n} ( {x}_{i} - \overline{x} ) ( {y}_{i} - \overline{y} )}{{\sum }_{i = 1}^{n} {( {x}_{i} - \overline{x} )}^{2}} \qquad ( 2 )$$
wherein xᵢ is a difference between i^{th} data time and the current time in the last 5 minutes, yᵢ is a monitoring value at the i^{th} data time, x̅ is an average value of xᵢ in the last 5 minutes, y̅ is an average value of yᵢ in the last 5 minutes, and n is the total amount of monitoring data in the last 5 minutes;
a calculation method for the geographic interpolation index Q is as follows: the interpolation index Q at position 0 is directly valued based on the geographic data cloud maps; and a specific calculation formula is as follows:
$$Q = {f}_{0} \qquad ( 3 )$$
wherein f₀ is a value at a corresponding grid point, and h is spacing of grid points;
a calculation method for the geographic gradient index G is as follows: the gradient index G at position 0 is 2-norm of the gradient here, and gradient calculation is based on a finite difference method; and a specific calculation formula is as follows:
$$G = {‖ \frac{{f}_{1} - {f}_{3}}{2 h} \vec{i} + \frac{{f}_{4} - {f}_{2}}{2 h} \vec{j} ‖}_{2} \qquad ( 4 )$$
wherein f₁, f₂, f₃ and f₄ are values at four grid points, and h is spacing of grid points;
critical values of the maximum value index M of the monitoring value and the geographic interpolation index Q are determined by critical values of a corresponding type of monitoring data set in Coal Mine Safety Regulations and other coal industry regulation documents, and critical values of the variation trend index Sₜ of the monitoring value and the geographic gradient index G are set empirical constants.

5. The mine disaster tracing method based on a knowledge graph as claimed in claim 1, characterized in that: in the S2, characteristic indexes of entity objects are constructed, transmission rules of the entity objects are determined, and the entity objects are divided into four types according to the needs of data types: a discrete reporting type, a continuous monitoring type, a geological structure type and a geological continuity type.

6. The mine disaster tracing method based on a knowledge graph as claimed in claim 5, characterized in that: the characteristic indexes and transmission rules of the entity objects of the discrete reporting type are compared with a normal threshold interval of the entity objects based on latest reported data; if beyond the normal threshold interval, the transmission rules are satisfied; otherwise, the transmission rules are not satisfied.

7. The mine disaster tracing method based on a knowledge graph as claimed in claim 5, characterized in that: the characteristic indexes and transmission rules of the entity objects of the continuous monitoring type comprise judgment of a sensor monitoring status and a sensor monitoring value; firstly, the sensor monitoring status is judged; if the monitoring status is “faulty” or “off-line”, it is directly determined that the transmission rules are satisfied; otherwise, next judgment is made; and then, the maximum value index M and the variation trend index Sₜ of the monitoring value of the sensor in the last 5 minutes are calculated, and the rule is that if one of the two indexes exceeds the critical value, the transmission rules are satisfied; otherwise, the transmission rules are not satisfied.

8. The mine disaster tracing method based on a knowledge graph as claimed in claim 5, characterized in that: the characteristic indexes and transmission rules of the entity objects of the geological structure type are determined by intersection of a structure buffer area, and the rule is that if an early warning area intersects with a 20 m buffer area of the geological structure, the transmission rules are satisfied; otherwise, the transmission rules are not satisfied.

9. The mine disaster tracing method based on a knowledge graph as claimed in claim 5, characterized in that: the characteristic indexes and transmission rules of the entity objects of the geological continuity type are determined by thresholds of geographic cloud maps, the indexes are a geographic interpolation index Q and a geographic gradient index G, and the rule is that if one of the two indexes exceeds the critical value, an anomaly exists; otherwise, no anomaly exists.

10. The mine disaster tracing method based on a knowledge graph as claimed in claim 1, characterized in that: in the S1, on the constructed mine disaster-related knowledge graph, based on the established transmission rules of entity objects and combined with a depth-first algorithm, a breadth-first algorithm or an A* algorithm graph traversal algorithm, mine disaster tracing is carried out to generate a disaster cause tree, and direct causes and root causes of a disaster are finally found.
